(19) United States
(12) Patent Application Publication
(10) Pub. No.: US 2015/0281008 A1
(43) Pub. Date: Oct. 1, 2015

(54) AUTOMATIC DERIVATION OF SYSTEM PERFORMANCE METRIC THRESHOLDS

(71) Applicant: Emulex Corporation, Costa Mesa, CA (US)

(72) Inventors: Nishant Kumar, Bangalore (IN); Vipul Srivastava, Bangalore (IN)

(73) Assignee: Emulex Corporation, Costa Mesa, CA (US)

(21) Appl. No.: 14/271,975

(22) Filed: May 7, 2014

(30) Foreign Application Priority Data
Mar. 25, 2014 (IN) 865/DEL/2014

(51) Int. Cl. H04L 12/26

(52) U.S. Cl. CPC H04L 43/04

(57) ABSTRACT

Methods and systems are provided for dynamically, adaptively and/or automatically managing performance metrics in infrastructures (e.g., network topologies). A network management device (e.g., datacenter server) may receive performance data relating to one or more performance metrics monitored in a managed infrastructure; and may determine for each performance metric, whether performance is acceptable or not, based on one or more performance parameters (e.g., thresholds) used in evaluating performance. The performance parameters may be set to allow for a plurality of acceptable performance criteria (e.g., expected mean, deviation, etc.). Further, the performance parameters may be set and/or adjusted dynamically and/or adaptively, such as to allow variations (e.g., time-based) in acceptable performance. Thus, determining whether performance is acceptable or unacceptable may be based on matching (e.g., time-based) of received performance data with an applicable one of the plurality of acceptable performance criteria. In addition, performance management may comprise monitoring for slow degradation.

### CLAIM OF PRIORITY

This patent application claims the filing date benefit of and right of priority to Indian Patent Application No. 865/DE112014, which was filed on Mar. 25, 2014. The above stated application is hereby incorporated herein by reference in its entirety.

### FIELD

Aspects of the present application relate to networking. More specifically, certain implementations of the present disclosure relate to automatic derivation of system performance metric thresholds.

### BACKGROUND

Existing methods and systems for utilizing links in generating and/or using system performance metrics, and thresholds applicable thereto, may be inefficient, and may result in under-utilization of resources and reduction in performance. Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

Systems and/or methods are provided for automatic derivation of system performance metric thresholds, substantially as shown in and/or described in connection with at least one of the figures, as set forth in the claims.

### BRIEF DESCRIPTION OF THE DRAWINGS

FIG. 1 illustrates an example network topology, which may support adaptive management of performance metrics.

FIG. 2 illustrates an example system which may be used to support adaptive management of performance metrics in networks.

FIG. 3 illustrates example timing charts of a tracked performance metric, and use thereof in adaptive management of the performance metric.

FIG. 4 illustrates an example time-based data sorting scheme, for use in adaptive management of performance metrics.

FIG. 5 is a flowchart illustrating an example process for tracking and utilizing performance metrics data in adaptive manner.

FIG. 6 illustrates a chart of an example scenario of slow degradation of a tracked performance metric.

FIG. 7 is a flowchart illustrating an example process for handling slow degradation of performance metrics data.

### DETAILED DESCRIPTION

As utilized herein the terms “circuits” and “circuitry” refer to physical electronic components (“hardware”) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

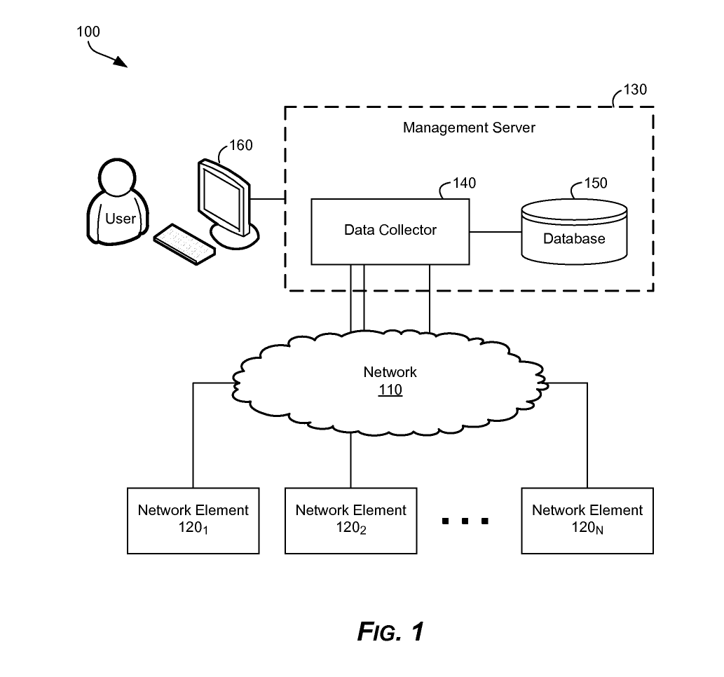

FIG. 1 illustrates an example network topology, which may support adaptive management of performance metrics. Referring to FIG. 1, there is shown a network topology 100. The network topology 100 may comprise a plurality of systems, devices, and/or components, for supporting interactions in accordance with various types of connections, interfaces, and/or protocols. For example, as shown in FIG. 1, the example network topology 100 may comprise a network 110, a plurality of network elements 120₁-120_{N}, and a management server 130.

The network 110 may comprise a system of interconnected nodes and/or resources (hardware and/or software), for facilitating exchange and/or forwarding of data among a plurality of devices (e.g., the network elements 120₁-120_{N}, the management server 130, etc.), based on one or more networking standards. Physical connectivity within, and/or to/from the network 110, may be provided using wired connectors (e.g., copper wires, fiber-optic cables, and the like) and/or wireless links. The network 110 may correspond to, for example, any suitable telephony network (e.g., landline based phone network, cellular network, etc.), satellite network, the Internet, local area network (LAN), wide area network (WAN), or any combination thereof.

Each of the network elements 120₁-120_{N} may comprise suitable circuitry for implementing various aspects of the present disclosure. For example, a network element, as used herein, may comprise suitable circuitry configured for performing or supporting various functions, operations, applications, and/or services. The functions, operations, applications, and/or services performed or supported by the network element may be run or controlled based on user instructions and/or pre-configured instructions. Further, each network element 120, may support communication of data, such as via wired and/or wireless connections, in accordance with one or more supported wireless and/or wired protocols or standards. While the network elements 120₁-120_{N} are shown in FIG. 1 as being external to the network 110, the disclosure is not so limited. Rather, some network elements may be part of the network 110, being used as resources therein in support of the network 110 and services provide thereby (e.g., as switching, routing, and/or bridging elements).

In some instances, each network element 120, may be configured to obtain and/or report performance related information. The performance related information may relate to the network element 120, itself and/or operations in the network topology 100 as a whole. Examples of network elements may comprise personal computers (e.g., desktops, and laptops), servers, switches and/or other forwarding equipment (e.g., bridges, routers, etc.), input/output (I/O) resources, storage resources (e.g., logical unit numbers or LUNs), and the like. The disclosure, however, is not limited to any particular type of network element.

The management server 130 may comprise suitable circuitry for implementing various aspects of the present disclosure. For example, the management server 130, as used herein, may comprise suitable circuitry configured for managing the network topology 100, particularly managing performance of the network topology 100 as a whole, and/or of various components of the network topology 100. In this regard, the management server 130 may be operable to obtain performance related information, and/or to process that information. The processing of the obtained performance related information may comprise, for example, determining acceptable ranges for fluctuations in performance, and/or reacting to deviations beyond such acceptable ranges.

To enable providing such management functions, the management server 130 may support communication of data, such as via wired and/or wireless connections, in accordance with one or more supported wireless and/or wired protocols or standards. The management server 130 may be implemented as a dedicated system, such as an electronic system with components that are particularly designed to support the functions performed by it. Alternatively, the management server 130 may be implemented using a general purpose machine, which may be programmed to function as a management server.

In the example implementation shown in FIG. 1, the management server 130 may comprise a data collector 140 and a database 150. The data collector 140 may comprise suitable circuitry for interacting with components of the network topology 100 (e.g., to obtain performance related data), for requesting and/or receiving the performance related data, and/or for processing the performance related data. The database 150 may comprise suitable circuitry for storing data, particularly performance related data (e.g., data received from network elements, and performance related parameters, which may be determined by the data collector 140, etc.) Further, the database 150 may be configured to support storage of data (e.g., received performance related data) in a particular manner, as explained in more detail with respect to at least some of the following figures. In some instances, the management server 130 may also incorporate and/or may be coupled to suitable input/output (I/O) devices (e.g., display, keyboard, mouse, etc.) 160, to allow user interactions with the management server 130 by suitable users (e.g., system administrators), such as to allow providing (outputting) performance related information to the user(s), and/or to allow receiving (inputting) performance related instructions or commands from the user(s).

In various implementations in accordance with the present disclosure, the network topology 100 may be configured to support providing automatic, dynamic, and/or adaptive management of performance metrics. In this regard, system administrators may need to track performance. Performance tracking may be done by periodically collecting performance metrics data from infrastructure components (e.g., servers, switches, analyzers etc.). Performance metrics may comprise any indicator of performance in the infrastructure, such as bandwidth, input/output (I/O) latency, active input/output (I/O) path count, equipment failure, etc. The collected data may be stored and accumulated over time. Such accumulated data may be used to assess performance of the infrastructure, and/or to allow devising guidelines and/or rules to help determine when performance becomes unacceptable. In this regard, accumulated (historical) data may be used to determine typical/expected performance, which in turn may allow assessing when/if new reported values deviate from such typical/expected performance. For example, determining typical/expected performance may comprise determining a historical mean based on the accumulated (historical) data, and determining when/if new reported values deviate from the typical/expected performance may entail comparing the new reported values against this mean.

In some instances, it may be desirable to permit particular performance metrics to fluctuate with certain ranges, such as to allow for certain degree of “acceptable” deviations from anticipated or target performance. Deviating beyond such ranges, however, may need to be noted and/or addressed. This may be achieved by use of thresholds—that is parameters that define acceptable limits (above and/or below) target values for particular performance metric(s). Accordingly, in some instances, thresholds may be set for particular performance metrics, for use in monitoring and handling performance fluctuation. Thus, when determining when/if new reported values deviate from the typical/expected performance (e.g., by comparing them to the historical mean), such threshold would be taken into consideration. When a reported value (of particular performance metric) crosses a threshold, some action may be taken (e.g., raising an alarm, so that preventive action can be taken). For example, if I/O latency in network 100 crosses above a particular threshold (indicating, for example, a possible system or network issue), I/O path availability goes below threshold (indicating, for example, possible forthcoming network outage), or a data rate for particular network element (e.g., server) crosses threshold (indicating, for example, that the server is exceeding its guest capacity and/or it may require re-configuration), an alarm may be raised.

The thresholds may be set by users—e.g., prompting and/or allowing authorized users to set threshold value(s) for particular performance metrics. However, setting thresholds in such manner (e.g., manually, by the users) may pose certain challenges. For example, setting thresholds manually may be cumbersome as it may require knowledge of historical data trends, and for many components/resources. A managed environment (e.g., the network topology 100) may have, for example, thousands of entities (servers, switches, I/O Paths, storage LUNs) to be monitored; with each entity potentially needing multiple different thresholds based on its usage. Further, while manually-set thresholds are fixed, performance related conditions (e.g., equipment load or utilization) may actually vary with time.

Accordingly, it may be desirable to use a performance management scheme which may be configured to function, at least in part, automatically—e.g., setting certain parameters used in evaluation performance (e.g., thresholds) automatically. Such automatic operation may be done in lieu of and/or in combination with manual operations—e.g., thresholds may be set automatically instead of or in conjunction with manually setting the thresholds by system users. Further, such performance management scheme may be configured such that to account and/or allow for ‘normal’ (or predictable) fluctuations in tracked performance values, and/or ‘normal’ (or predictable) fluctuations in “acceptable” performance ranges relating thereto, for particular performance metrics—e.g., based on time or the like. Thus, the performance management may comprise determining when particular performance metrics deviate beyond any applicable “acceptable” range(s)—e.g., whichever range(s) that may applicable based on pertinent conditions—such as in time-based conditions (e.g., time when performance data is collected). The performance management may also comprise addressing situations when deviation(s) beyond such ranges occur.

This may be achieved by providing automatic, dynamic, and/or adaptive management of performance metrics, which may comprise automatically, dynamically, and/or adaptively setting (or adjusting) parameters used in performance management, such as thresholds. Nonetheless, while some of the implementations are described herein with respect to thresholds, it should be understood that the disclosure is not so limited, and that a similar approach may be applied to any other performance related parameter that may be set and/or adjusted in an automatic, dynamic, and/or adaptive manner.

In this regard, threshold values may be set automatically, dynamically, and/or adaptively (e.g., in or by the management server 130), whereby the thresholds may be set for each element by processing historical data for the element, and/or while taking into consideration factors that may allow for varying the threshold in an adaptive manner—e.g., as function of time. For example, certain performance metrics (e.g., system/network load) may be allowed to fluctuate differently at different times, based on prior knowledge or anticipated behavior (e.g., low load being expected on transactional systems in certain times, such as between 12 PM to 2 PM, as it is typically lunch time; high network load may be expected in some datacenters between 12 AM to 4 AM each day, due to nightly backup jobs; high load may be expected on certain social networking servers during weekends; high load may be expected on certain financial processing systems in March, due to end of fiscal year). Nonetheless, while some of the implementations are described herein with respect to setting and/or adjusting performance related parameters (e.g., thresholds) based on time, it should be understood that the disclosure is not so limited, and that a similar approach may be applied to any other conditions and/or factors that may affect performance related parameters.

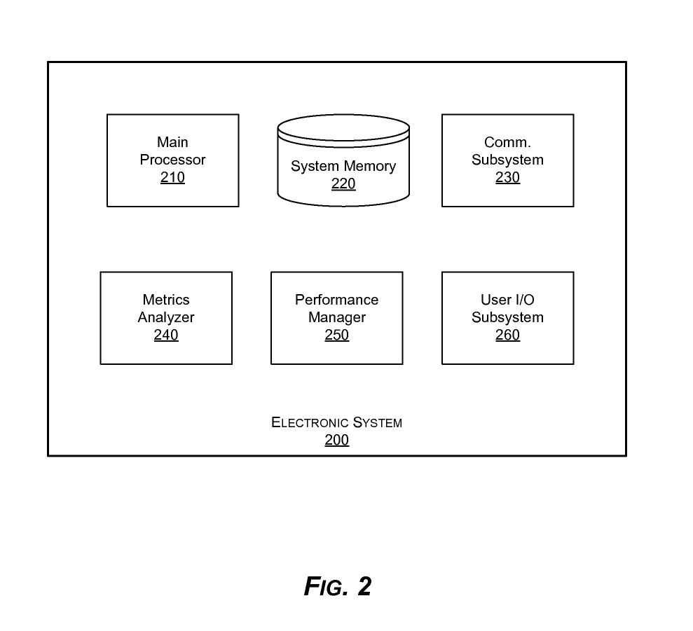

FIG. 2 illustrates an example system which may be used to support adaptive management of performance metrics in networks. Referring to FIG. 2, there is shown an electronic system 200.

The electronic system 200 may comprise suitable circuitry for implementing various aspects of the disclosure. The electronic system 200 may correspond to (at least a portion of) the management server 130 of FIG. 1. The electronic system 200 may comprise, for example, a main processor 210, a system memory 220, a communication subsystem 230, a metrics analyzer 240, a performance manager 250, and a user input/output (I/O) subsystem 260.

The main processor 210 may comprise suitable circuitry for performing various general and/or specialized processing operations in and/or for the electronic system 200. For example, the main processor 210 may comprise a general purpose processor (e.g., a central processing unit or CPU). Alternatively, the main processor 210 may comprise a special purpose processor, such as a dedicated application processor (e.g., ASIC), which may be utilized in running and/or executing particular applications in the electronic system 200. The disclosure, however, is not limited to any particular type of processors. When utilized as a general purpose processor, the main processor 210 may be configured to, for example, process data, control or manage operations of the electronic system 200 (or components thereof), and/or execute or perform various programs, tasks and/or applications performed in the electronic system 200. For example, when controlling and/or managing the electronic device, the main processor 210 may be utilized to configure and/or control operations of various components and/or subsystems of the electronic system 200, by utilizing, for example, one or more control signals.

The system memory 220 may comprise suitable circuitry for providing permanent and/or non-permanent storage, buffering, and/or fetching of data, code and/or other information, which may be used, consumed and/or processed in and/or for the electronic system 200. In this regard, the system memory 220 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage device. The system memory 220 may store, for example, configuration data, which may comprise parameters and/or code, comprising software and/or firmware.

The communication subsystem 230 may comprise suitable circuitry for supporting communication of data to and/or from the electronic system 200. For example, the communication subsystem 230 may comprise suitable circuitry for providing signal processing, for performing wireless transmission and/or reception (e.g., via antenna(s), such as over a plurality of supported RF bands), and/or for transmitting and/or receiving signals via a plurality of wired connectors (e.g., in accordance with one or more wired protocols, such as Ethernet). The signal processing performed by the communication subsystem 230 may be configured in accordance with one or more wired or wireless protocols supported by the electronic system 200. The signal processing may comprise such functions as filtering, amplification, up-conversion/down-conversion of baseband signals, analog-to-digital conversion and/or digital-to-analog conversion, encoding/decoding, encryption/decryption, modulation/demodulation, and the like.

The metrics analyzer 240 may comprise suitable circuitry for processing metrics related data, such as reported performance metrics data. For example, the metrics analyzer 240 may be operable to analyze performance metrics data, such as to determine the pertinent performance metric(s), to identify the reporting entity, and/or to assess condition relating to the collection of the data (e.g., time). Further, in some instances, the metrics analyzer 240 may extract information from reported performance metrics data, and/or may store at least some of the information extracted from the reported performance metrics data.

The performance manager 250 may comprise suitable circuitry for managing performance, such as in a network topology managed by using the electronic system 200. For example, the performance manager 250 may be operable to manage performance by monitoring one or more performance metrics, to detect when/if there may be any deviations from acceptable performance values. Further, the performance manager 250 may be operable to set and/or adjust performance parameters (e.g., thresholds) which may be used in assessing performance (e.g., determining when there are any fluctuations or deviations, and/or whether they are beyond acceptable limits).

The user I/O subsystem 260 may comprise suitable circuitry for supporting user interactions with the electronic system 200, such as via I/O devices (e.g., display, keyboard, mouse, etc.) incorporated into and/or coupled to the electronic system 200. Thus, the user I/O subsystem 260 may be operable to provide user output (status, alarms, etc.) to suitable (authorized) system users by using information available via the electronic system 200, and/or to obtain user input (e.g., data, instructions, settings, commands, etc.) to such system users.

In operation, the electronic system 200 may be utilized in management of network topologies, particularly with respect to management of performance metrics used therein. In this regard, the electronic system 200 may communicate with network elements in a managed network topology, such as to obtain performance metrics data and/or to send performance management related information thereto (e.g., information regarding applicable thresholds, commands or instructions issued for the purpose of trying to remedy alarms raised in response to performance metrics data, etc.) For example, the communication subsystem 230 may be utilized in and/or to the electronic system 200, over the established connections.

In various implementations, the electronic system 200 may be configured to perform management in particular infrastructures, such as network topologies (e.g., the network topology 100 of FIG. 1). In particular, the electronic system 200 may be configured to provide automatic, dynamic, and/or adaptive performance management, such as via the performance manager 250, substantially as described with respect to FIG. 1. For example, the performance manager 250 may be used for managing performance, such as by monitoring one or more performance metrics in the managed infrastructure(s), and/or to enable detecting when/if there may be any deviations from acceptable performance criteria (e.g., values or ranges). The monitoring may be performed based on performance data (e.g., values of one or more performance metrics), which may be reported to the electronic system 200 by entities (e.g., network elements) in the managed infrastructure(s). The electronic system 200 may receive the performance data by using connections established via the communication subsystem 230.

The metrics analyzer 240 may analyze the received performance data. For example, metrics analyzer 240 may analyze the received performance data to match it with corresponding performance metric(s), to which the reported data pertain; to identify the reporting entities, and/or to assess conditions relating to the collection of the data (e.g., time of collection). The metrics analyzer 240 may then extract information from reported performance metrics data, and/or may store (e.g., in the system memory 200) at least some of the information extracted from the reported performance metrics data. In this regard, storing the extracted information may be done, in some instances, in a particular manner that may be optimized to support adaptive performance management. As result, as described in more detail in to the following figures, handling of received data is based on time (e.g., time of collection), such as to enable varying performance analysis for different times. Thus, a certain measure of deviation, for a particular performance metric and/or a particular entity, may be determined to be acceptable in particular times, but not acceptable otherwise.

In some instances, the performance manager 250 may be operable to set and/or adjust performance parameters (e.g., thresholds) which may be used in assessing performance, such as in determining when/if there are any fluctuations or deviations, and/or whether such fluctuations or deviations exceed acceptable limits. While the performance parameters may be set by system user(s), such as through user I/O subsystem 260, the performance manager 250 may also be operable to automatically, dynamically, and/or adaptively set at least some of the performance parameters. For example, the performance manager 250 may be configured to set threshold(s) for one or more of monitored performance metrics, and to do so automatically, dynamically, and/or adaptively—e.g., based on prior knowledge and/or anticipated behavior of pertinent components in the management infrastructure(s). An example of time-based adaptive management of thresholds is described in more detail with respect to the following figures. In some instances, the performance manager 250 may also be operable to monitor the performance metrics and/or performance parameters, such as to guard against gradual degradation that may otherwise be undetected.

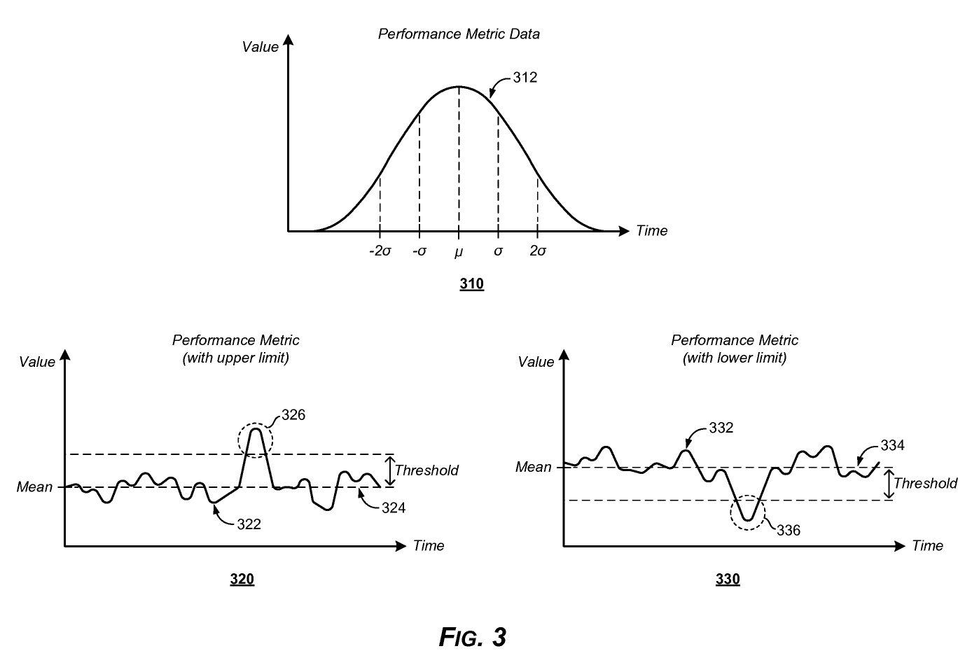

FIG. 3 illustrates example timing charts of a tracked performance metric, and use thereof in adaptive management of the performance metric. Referring to FIG. 3, there is shown timing charts 310, 320, and 330, which may correspond to tracking performance data for a particular performance metric.

For example, the timing chart 310 depicts an example distribution of obtained data (values) for a particular performance metric (e.g., network load). As shown in chart 310, the distribution of historical data values for a particular performance metric may be in the form of a normal distribution 312. Nonetheless, while normal distribution is depicted and described in FIG. 3, the disclosure is not so limited, and various forms and/or types of distributions of historical data values for performance metrics may be used and/or handled in a substantially similar manner. The distribution of obtained data may be used to determine one or more parameters that may be used in evaluating performance—e.g., parameters which may be used in assessing what constitutes “acceptable” performance. The distribution of historical data values may be used in determining, for example, a mean (μ) of the values, as well as a standard deviation (from the mean). In this regard, the mean and the standard deviation may be used to support performance management—e.g., to enable determining and/or setting of acceptable range(s) of variation for corresponding performance metrics. For example, the mean (μ) and standard deviation (σ) may be determined using the formula:

μ=Σxᵢ/N (1)

σ=((Σ(xᵢ−μ)²)/(N−1))^{1/2} (2)

Where xᵢ may be an instance of data record value; N may be total number of data elements; μ may be the mean of distribution; and σ may be standard deviation.

The mean and standard deviation may be used in setting thresholds, which in turn may allow determining when values of a performance metric deviate beyond acceptable range(s). For example, for performance metrics (e.g., throughput) requiring a lower limit as threshold, the threshold may be set as: μ−σ; whereas for performance metrics (e.g., network load) requiring a lower limit as threshold, the threshold may be set as: μ+σ. Thus, alarms may be raised based on the set thresholds—e.g., when captured data crosses computed threshold(s). This is depicted in example timing charts 320 and 330.

The timing chart 320 depicts example recorded data values of a performance metric requiring an upper limit. In particular, as data values are obtained over time and recorded, as indicated as solid line 322, they typically fall near a mean (μ), as indicated as dashed line 324, deviating from it by particular deviation margin (e.g., above or below the mean (μ) 324). The deviation margin is compared against an upper threshold that may be determined based on, for example, a standard deviation (σ) (or any other type of deviation), which may be calculated (along with the mean (μ) 324), e.g., from historical data (as shown in chart 310, for example)—e.g., the upper threshold may be set to μ+σ. Where the recorded data deviates from the mean beyond (above) the upper threshold (e.g., area 326), an alarm may be raised and/or further action(s) may be taken to address the situation (to bring down the value of the performance metric, such as the network load).

Similarly, the timing chart 330 depicts example recorded data values of a performance metric requiring a lower limit. In particular, as data values are obtained over time and recorded, as indicated as solid line 332, they typically fall near a mean (μ), as indicated as dashed line 334, deviating from it by a particular margin (e.g., above or below the mean (μ) 334). The deviation margin is compared against a lower threshold that may be determined based on standard deviation (σ), which may be calculated (along with the mean (μ) 334), e.g., from historical data (as shown in chart 310, for example)—e.g., the lower threshold may be set to μ−σ. Where the recorded data deviates from the mean beyond (below) the lower threshold (e.g., area 336), an alarm may be raised and/or further action(s) may be taken to address the situation (e.g., to bring up the value of the performance metric, such as the network delay).

Such approach may ensure that tolerance of violation detection (e.g., detection of an unacceptable deviation from the mean) may be proportional to standard deviations—e.g., for heavily fluctuating performance metrics, the standard deviation (σ) is likely large, and as such thresholds may be further from the mean (μ); whereas for evenly distributed performance metrics, the standard deviation (σ) is likely small, and as such thresholds may be closer to mean (μ). Nonetheless, many solutions that use distribution based parameters (e.g., mean and standard deviation) in monitoring and managing performance (e.g., in setting thresholds) may suffer from significant shortcomings. For example, use of aggregated historical data in this manner may fail to account for what should be acceptable fluctuations (e.g., may essentially amount to an assumption that performance is uniform, when in reality it may normally fluctuate, such as on daily, weekly, and/or yearly basis). Further, many solutions that may be based on use of aggregate historical data (and/or distribution based parameters derived therefrom) may fail to account for and/or to handle situations where there is slow degradation over a period of time. Accordingly, the performance management scheme may be optimized or enhanced to particularly address such shortcomings. Thus, performance related parameters (e.g., thresholds) may be determined in dynamic and adaptive manner (thus, allowing for, e.g., accounting for normal fluctuations), and/or the scheme may be configured to particularly account for such conditions as slow degradation.

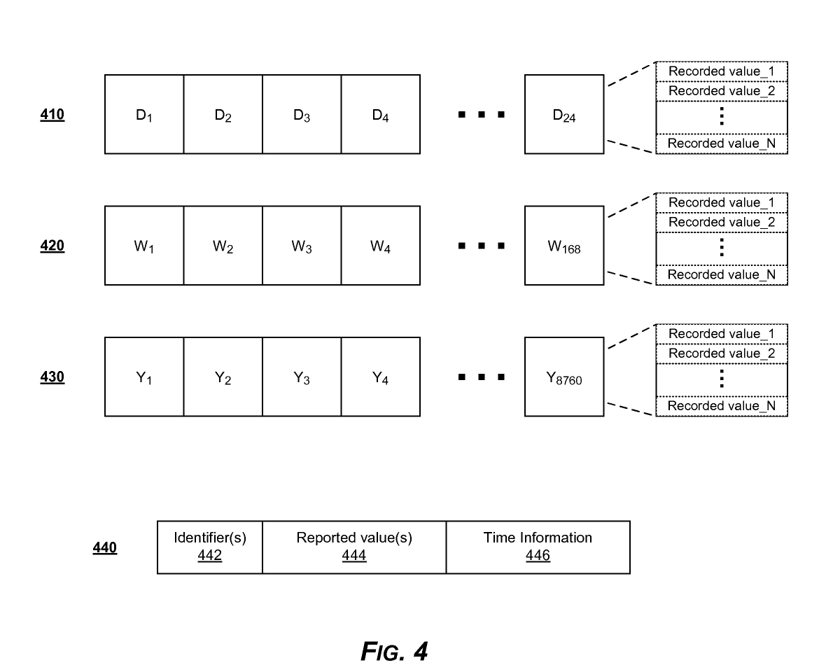

FIG. 4 illustrates an example time-based data sorting scheme, for use in adaptive management of performance metrics. Referring to FIG. 4, there are shown storage lists 410, 420, and 430.

Each of the storage lists 410, 420, and 430 may comprise a plurality of storage entries (referred to hereinafter as “buckets”), which may be used to store data, particularly performance metrics data. For example, each of the buckets in the storage lists 410, 420, and 430 may be used to store a plurality of recorded values (e.g., “N” values), corresponding to a particular performance metric. The storage lists 410, 420, and 430 may be configured and/or used in or by systems for managing network topologies, particularly with respect to performance metrics tracked therein. For example, the electronic system 200 may generate instances of the storage lists 410, 420, and 430 within the system memory 220, and may use them during performance metrics related operations. In this regard, the electronic system 200 may generate instances of the storage lists 410, 420, and 430 for each tracked performance metric. Alternatively, single instances of each of the storage lists 410, 420, and 430 may be used for all tracked performance metrics (e.g., by having separate value lists in each bucket for each tracked performance metric). Thus, when new performance data is reported, processing the new performance data may comprise identifying suitable buckets in the storage lists 410, 420, and 430, which (the buckets) may then be updated based on the reported new performance data.

The storage lists 410, 420, and 430 may be configured to enable storing of performance metrics data (and to configure processing thereof) in time-based manner—e.g., based on a time the data was generated or received. Storing the performance metrics data in such a time-based manner may allow for time-based adaptive evaluation of performance—e.g., allow and/or account for varying (acceptable) variation ranges, for particular performance metric(s), based on the time, as described with respect to FIG. 1 for example. New data may be reported such as to provide reported performance value(s) as well as timing information (e.g., when the data was obtained) and/or information identifying the element that obtained the data

For example, as shown in FIG. 4, the storage lists 410, 420, and 430 may be used to record collected/received performance metrics data on daily, weekly, and/or yearly basis. Nonetheless, while various implementations are described herein as providing time-based management in accordance with such regular time frames (e.g., in conjunction with daily, weekly, and/or yearly based tracking and/or processing), the disclosure is not so limited, and other criteria (time and/or non-time based) may be used in similar manner. For example, in some implementations, similar management schemes may be configured based on user specified time criteria, specifying one or more non-standard tracking cycles of various lengths. System users may be prompted, for example, to specify one or more time-based cycles that may be used in controlling the timing of the data collection, and subsequently the sorting of the collected data in a substantially similar manner as described herein with respect to the daily/weekly/yearly based scheme.

The storage list 410 may comprise 24 buckets (D₁ to D₂₄), corresponding to the total number of hours in a day, which may be used to record data for each hour of the day. The data recorded in this manner may then enable tracking of performance variations within a day, on an hourly basis. The storage list 420 may comprise 168 buckets (W₁ to W₁₆₈), corresponding to the total number of hours in a week, which may be used to record data for each hour of the week. Data recorded in this manner may enable tracking of performance variations within a day, on an hourly basis. The storage list 430 may comprise 8760 buckets (Y₁ to Y₈₇₆₀), corresponding to total number of hours in a year, which may be used to record data for each hour of the year. The storage lists 410, 420, and 430 hence may be used to record values for performance metrics on an hourly basis, per day, week, and year. Hence, monitoring (and handling) fluctuations in performance metrics may be configured such that it may be done independently on hourly basis within the day, within the week, and/or within the year.

In an example use scenario, in which storage lists 410, 420, and 430 may be used to record performance data when monitoring I/O latency in a network topology, which (I/O latency) presumably may be a performance metric requiring upper threshold(s). New data may be reported such as to provide reported performance value(s) as well as timing information (e.g., when the data was obtained) and/or information identifying the element that obtained the data. For example, received new data may be configured in accordance with a data structure 440, comprising an identifier(s) field 442, which may be used to identify the network element(s) providing the reported data, a reported metrics value(s) field 444, which may be used to report data values for one or more performance metrics, and a time-stamp information field 446, which may provide time related information (e.g., date, time of day, etc.) as to when reported data was obtained or collected.

In a particular example, the received new data may indicate (via field 442) that it was obtained via Element 1; may report (via field 444) a particular performance value (e.g., I/O latency value of 50 milliseconds); and may be time-stamped (via field 446) to indicate a particular time/date (e.g., indication that it was obtained: Mar. 3, 2013 (Sunday); at 05:30:00). Thus, the received new data may be represented as (Element1; 50; 05:30:00/03 MAR 2013). The received new data may then be processed, to identify corresponding buckets in the storage lists 410, 420, and 430, and the identified buckets may be used to determine if there are any unacceptable deviations in performance (for the pertinent performance metrics). Further, the identified buckets may be updated by using the newly reported value.

For example, with respect to the particular new data described above, the three corresponding buckets may be determined as: bucket D₅, because the reported data was obtained in the 5th hour of day; bucket W₅, because the reported data was obtained in the 5th hour of the week (since it was obtained during the 5th hour on Sunday, which is the first day of the week); and bucket Y₁₄₆₉, because the reported data was obtained in the 1469th hour of the year (since it was obtained during the 5th hour of the Mar. 3, 2013, which corresponds to hour number: 24*(31+28+2)+5, or 1469, since the start of the year). Thus, the newly reported value (50) for I/O latency may be processed based on each of the identified buckets D₅, W₅, and Y₁₄₆₉. In particular, it may be determined whether the newly reported value may cross applicable threshold(s)—e.g., based on present mean and standard deviation for each identified bucket. Further, these buckets may then be updated, to include thereafter the new reported value.

For example, assuming that before receiving the new data, bucket D₅ may have contained the values: [30, 20, 25, 27, 31, 33, 35, 10, 24]; bucket W₅ may have contained the values: [40, 30, 23, 22, 30, 37, 45, 20, 44]; and bucket Y₁₄₆₉ may have contained the values: [60, 65, 62, 64, 62], and the mean and standard deviation are calculated based on these present recorded values, for each of these buckets, using formula (1) and (2) described above. Doing so may yield: σ=7.65579 and μ=26.11111 for bucket D₅; σ=9.57862 and μ=32.33333 for bucket D₅; and σ=1.94936; μ=62.6 for bucket Y₁₄₆₉ Thus, the threshold (assuming upper limit based thresholds) may be for each bucket: 33.7669 (7.65579+26.11111) for D₅; 41.91195 (9.57862+32.33333) for bucket W₅; and 64.54936 (1.94936+62.6) for bucket Y₁₄₆₉ Thus, only daily- and weekly-based alarms may be raised, since the new value exceeds the present daily- and weekly-based thresholds (50>33.7669 and 50>41.91195); but no yearly-based alarm would be raised, since the new value (50) does not cross the present year-based threshold (50<64.54936).

Further, once the determination is made (whether or not the new value crosses the present threshold(s)), the new data record may be pushed into identified buckets. Thus, bucket D₅ then contains the values: [30, 20, 25, 27, 31, 33, 35, 10, 24, 50]; bucket W₅ then contains the values: [40, 30, 23, 22, 30, 37, 45, 20, 44, 50]; and bucket Y₁₄₆₉ then contains the values: [60, 65, 62, 64, 62, 50]. Accordingly, the new recorded value (50) would thereafter alter the daily-, weekly-, and yearly-based mean and standard deviation.

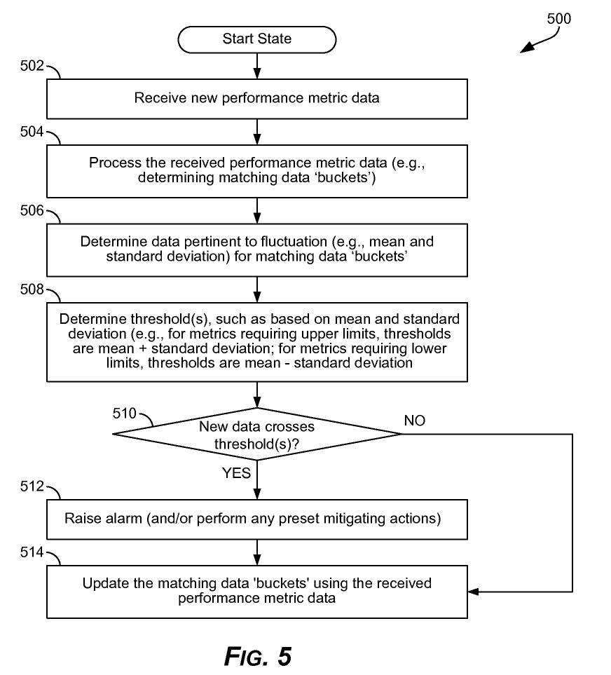

FIG. 5 is a flowchart illustrating an example process for tracking and utilizing performance metrics data in adaptive manner. Referring to FIG. 5, there is shown a process flow chart 500, comprising a plurality of example steps.

In step 502, new performance metric data may be received (e.g., from an element in a managed infrastructure). In example step 504, the received performance metric data may be processed. The processing may comprise, e.g., determining matching data “buckets” which may be used to store corresponding historical (reported) data.

In step 506, data pertinent to performance fluctuation (e.g., mean and standard deviation) may be determined. This may be done by using historical data in matching data buckets. In step 508, performance parameters (e.g., threshold(s)) may be determined, such as performance fluctuation related data (mean and standard deviation) as determined in step 506. Determining the performance parameters may also depend upon the manner by which performance is assessed—e.g., for performance metrics requiring upper limits, thresholds may be set to mean+standard deviation (e.g., μ+σ); whereas for performance metrics requiring lower limits, thresholds may be set to mean−standard deviation (e.g., μ−σ).

In step 510, it may be determined whether the new received data results in an unacceptable deviation (e.g., cross applicable threshold(s)). In instance, where the new received data do NOT result in unacceptable deviation, the process 500 may jump to step 514; otherwise the process 500 proceeds to step 512. In step 512, corresponding alarm(s) may be raised (and, were applicable, any preset mitigating actions may be performed). In step 514, the matching data ‘buckets’ (identified in step 506) may be updated by using the received performance metric data.

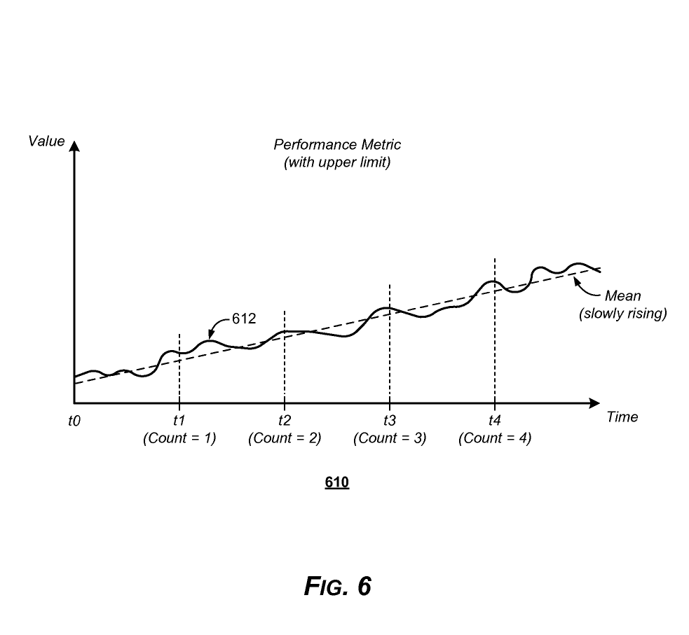

FIG. 6 illustrates a chart of an example scenario of slow degradation of a tracked performance metric. Referring to FIG. 6, there is shown a timing chart 610.

The timing chart 610 depicts a graph 612 of example recorded data values for a particular performance metric requiring an upper limit. In particular, the timing chart 610 depicts example gradual (slow) degradation in recorded performance data values. In a slowly degrading scenario, the mean of the recorded data values may keep increasing (or decreasing), until the system eventually fails. Further, in some instances the system failure may occur without causing any alarm(s), since the rate of degradation may be so slow as to not cause crossing of any applicable threshold(s). Thus, it may be desirable to particularly incorporate dedicated means (e.g., logic) for monitoring and detecting such scenarios. Such degradation detection logic may be used, for example, in conjunction with the threshold computation logic described above (e.g., the logic utilized to automatically, dynamically, and/or adaptively setting thresholds). The disclosure is not so limited, however, and other mechanisms may also be used (e.g., based on standard statistical methods, and/or using bucket based monitoring, for example).

In an example particular implementation, slow degradation may be monitored and/or detected, while monitoring for crossings of thresholds is performed, over continuous intervals, such as by checking for a certain number of increases (or decreases), in sequence (e.g., in a row), over these continuous intervals. For example, the value of the mean of graph 612 may be determined at intervals tᵢ (of which, t₀-t₄ are shown), and compared to prior values (e.g., relative to a value at a prior interval) and whenever the mean is increased (or decreased) a counter is incremented, until either a maximum number of increases (or decreases) is reached, before detecting no change of the mean (or change in opposite direction—e.g., increase after decrease). When such maximum number of consecutive increases (or decreases) is reached, an alarm maybe raised (and, in some instances, actions may be taken to mitigate that problem, such as in accordance with user commands). For example, if the maximum count (e.g., maximum number of in-row increases or decreases) is 4, an alarm may be raised once the fourth increase in row is detected at t₄.

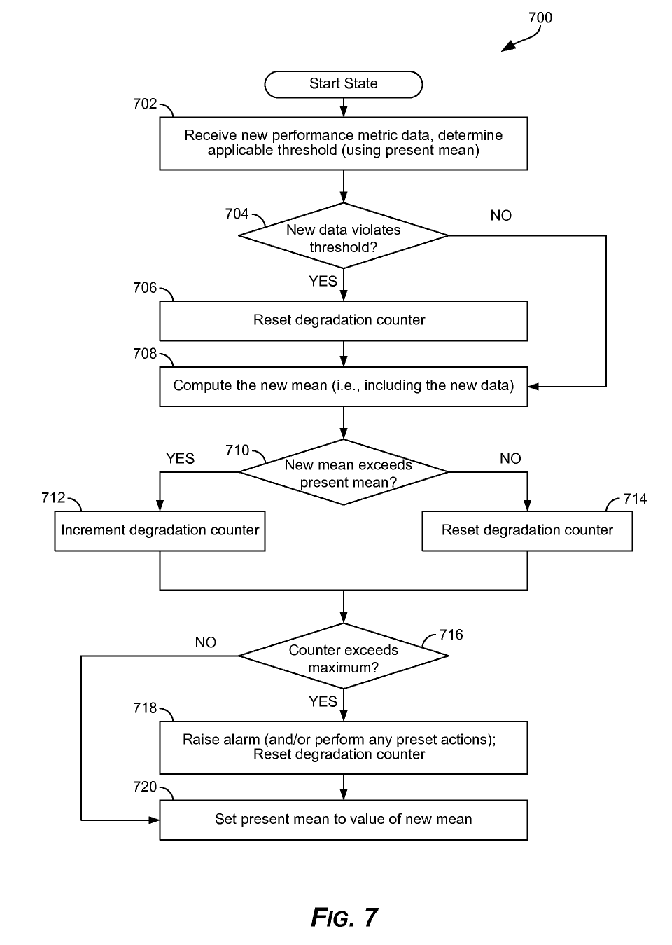

FIG. 7 is a flowchart illustrating an example process for handling slow degradation of performance metrics data. Referring to FIG. 7, there is shown a flow chart 700, comprising a plurality of example steps.

In step 702, new performance metric data may be received (e.g., from an element in a managed infrastructure), and processed to enable determining of applicable performance parameters (e.g., threshold). This may also comprise determining a present expected value (e.g., present mean).

In step 704, it may be determined whether new performance metric data results in unacceptable performance deviation (e.g., crossing of the threshold). If not, the process may jump to step 708; otherwise (e.g., there was an unacceptable deviation), the process proceeds to step 706, where a counter is used for tracking degradation (“degradation counter”) may be reset (e.g., to zero), before proceeding to step 708.

In step 708, a new expected value (e.g., new mean) may be determined by using the new data (as well as historical, recorded data). In step 710, it may be determined whether the new expected value exceeds the present expected value (e.g., new mean exceeds present mean). The determination may be adaptively made based on the particular performance scenario. For example, with performance metrics requiring upper limits, the determination is based on the check: new mean>=present mean. If the new expected value did exceed the present expected value, the process may proceed to step 712, where the degradation counter is incremented; otherwise (e.g., the new expected value does NOT exceed the present expected value), the process may proceed to step 714, where the degradation counter may be reset. Either way, the process proceeds to step 716.

In step 716, it may be determined whether the degradation counter exceeded a preconfigured maximum value (e.g., 4). If not (e.g., the degradation counter did NOT exceed the maximum value), the process may jump to step 720; otherwise (e.g., the degradation counter did exceed the maximum value), the process proceeds to step 718, where an alarm is raised (and/or, where applicable, any preset mitigating actions may be performed) and the degradation counter is reset, before proceeding to step 720. In step 720, the present expected value (e.g., present mean) is set to the new expected value (e.g., new mean).

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for enhancing active link utilization for SAS topology.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system, comprising:
one or more circuits for use in network management, the one or more circuits being operable to:
receive performance data relating to one or more performance metrics monitored in a managed infrastructure; and
for each performance metric, determine when performance is unacceptable, based on one or more performance parameters used in evaluating performance with respect to said each performance metric, wherein:
the one or more performance parameters are set to allow for a plurality of acceptable performance criteria, and
determining that performance is acceptable or unacceptable is based on matching received performance data with an applicable one of the plurality of acceptable performance criteria.

2. The system of claim 1, wherein each of the plurality of acceptable performance criteria specifies a particular expected value and a particular acceptable deviation from the particular expected value.

3. The system of claim 1, wherein the one or more performance parameters comprise thresholds that are used in determining acceptable deviations from expected values associated with the one or more performance metrics.

4. The system of claim 1, wherein the one or more circuits are operable to identify the applicable one of the plurality of acceptable performance criteria based on matching one or more parameters relating to the received performance data with a corresponding one or more parameters associated with the applicable one of the plurality of acceptable performance criteria.

5. The system of claim 1, wherein the one or more circuits are operable to process the received performance data, by:
determining a corresponding one or more data sorting groups used in recording reported performance data; and
updating the corresponding one or more data sorting groups, based on the received performance data.

6. The system of claim 1, wherein the one or more circuits are operable to:
determine based on the received performance data, a corresponding one or more data sorting groups used in recording reported performance data; and
determine based on data in the corresponding one or more data sorting groups, when performance is unacceptable for each performance metric.

7. The system of claim 6, wherein the one or more circuits are operable to determine when performance is unacceptable for each performance metric by determining at least part of the applicable one of the plurality of acceptable performance criteria based on data in the corresponding one or more data sorting groups.

8. The system of claim 1, wherein the one or more circuits are operable to dynamically set and/or adjust at least one performance parameter associated with at least one monitored performance metric based on recorded data associated with the at least one monitored performance metric, and/or based on conditions associated with recording the data associated with the at least one monitored performance metric.

9. The system of claim 8, wherein the one or more circuits are operable to dynamically set and/or adjust the at least one performance parameter associated with at least one monitored performance metric based on calculation of an expected value and a deviation from the expected value based on the recorded data associated with the at least one monitored performance metric, wherein the calculation is performed, at least in part, based on the conditions associated with recording the data associated with the at least one monitored performance metric.

10. The system of claim 1, wherein the one or more circuits are operable to monitor for gradual degradation associated with at least one monitored performance metric, the monitoring comprising detecting where there is a particular number of consecutive similar deviations from an expected value associated with the at least one monitored performance metric.

11. A method, comprising:
receiving in a network management device, performance data relating to one or more performance metrics monitored in a managed infrastructure; and
for each performance metric, determining when performance is unacceptable, based on one or more performance parameters used in evaluating performance with respect to said each performance metric, wherein:
the one or more performance parameters are set to allow for a plurality of acceptable performance criteria, and
determining that performance is acceptable or unacceptable is based on matching received performance data with an applicable one of the plurality of acceptable performance criteria.

12. The method of claim 11, wherein each of the plurality of acceptable performance criteria specifies a particular expected value and a particular acceptable deviation from the particular expected value.

13. The method of claim 11, wherein the one or more performance parameters comprise thresholds that are used in determining acceptable deviations from expected values associated with the one or more performance metrics.

14. The method of claim 11, comprising identifying the applicable one of the plurality of acceptable performance criteria based on matching one or more parameters relating to the received performance data with a corresponding one or more parameters associated with the applicable one of the plurality of acceptable performance criteria.

15. The method of claim 11, comprising:
determining a corresponding one or more data sorting groups used in recording reported performance data; and
updating the corresponding one or more data sorting groups, based on the received performance data.

16. The method of claim 11, comprising:
determining based on the received performance data, a corresponding one or more data sorting groups used in recording reported performance data; and
determining based on data in the corresponding one or more data sorting groups, when performance is unacceptable for each performance metric.

17. The method of claim 16, comprising determining when performance is unacceptable for each performance metric by determining at least part of the applicable one of the plurality of acceptable performance criteria based on data in the corresponding one or more data sorting groups.

18. The method of claim 11, comprising dynamically setting and/or adjusting at least one performance parameter associated with at least one monitored performance metric based on recorded data associated with the at least one monitored performance metric, and/or based on conditions associated with recording the data associated with the at least one monitored performance metric.

19. The method of claim 18, comprising dynamically setting and/or adjusting the at least one performance parameter the at least one performance parameter associated with at least one monitored performance metric based on calculation of an expected value and a deviation from the expected value based on the recorded data associated with the at least one monitored performance metric, wherein the calculation is performed, at least in part, based on the conditions associated with recording the data associated with the at least one monitored performance metric.

20. The method of claim 11, comprising monitoring for gradual degradation associated with at least one monitored performance metric, the monitoring comprising detecting where there is a particular number of consecutive similar deviations from an expected value associated with the at least one monitored performance metric.
